(19) United States
(12) Patent Application Publication
(10) Pub. No.: US 2005/0123164 A1
(43) Pub. Date: Jun. 9, 2005

(54) Mobile device cord holder

(76) Inventors: Caroline L. Yao, Alameda, CA (US); Beverly R. Scott, Alameda, CA (US)

Correspondence Address: Joseph R. Palmieri, 136 Turtle Cove Lane, Huntington, NY, 11743, US

(21) Appl. No.: 10/730,775

(22) Filed: Dec. 8, 2003

(51) Int. Cl. H04B 7/00; H04R 25/00

(52) U.S. Cl. 381/380; 381/374

(57) ABSTRACT

A cord holder for cords of mobile devices is described in a preferred embodiment of the present invention. The described cord holder includes a center region and two end regions, coupled on either longitudinal end of the center region. Each of the end regions is axially longer than the center region, forming retaining regions. The retaining regions are used to hold a cord in a non-tangling manner. The end regions include pincer regions having a gap, the gap resistively allowing passage of the earpiece cord into a holding area, thus allowing the ends of the earpiece cord to be secured. The amount of cord that is held by the cord holder is determinable by the user by choosing the locations of the cord that are inserted into the pincer regions. The cord holder thus allows for quick and tangle-free storage of excess cord until those times when extended cord length is desired. The preferred embodiment is a cord holder for use with an earpiece cord for a mobile device.

### BACKGROUND INFORMATION

Mobile phones, cellular phones, cordless phones, portable devices having audio capabilities (such as MP3 players), and other portable electronics (referred to herein collectively as “mobile devices”) have become extremely popular, as they allow for access to data and/or communications over public networks via devices that may be carried by the user (for example, in a clothing pocket or in a bag). To enhance the convenience of mobile devices, mobile device manufacturers may also provide for the use of certain accessories with the mobile device. One particularly popular accessory is sometimes known as an earpiece, one example of which is illustrated in FIG. 1. The earpiece in this case is a combination speaker-microphone (in FIG. 1, note speaker 1 and microphone 2) that may be attached to the mobile device, for example, via a port provided on the mobile device (in FIG. 1, note port 3) and mounted on a user's head such that sounds from the speaker may be heard by the user and words spoken by the user may be detected by the microphone. The signals used by the speaker and microphone are carried to and from the mobile device via an earpiece cord, which electrically connects the earpiece to the mobile device (in FIG. 1, note earpiece cord 4). Earpieces can be a convenient way to use the mobile device, as they require less effort than holding the device to the user's head while talking or listening (particularly over long periods of use) and may provide clearer communications. Earpieces are also popular due to “hands-free” mobile phone use laws that have been enacted in several jurisdictions, which require the use of a device that avoids the holding of mobile phone to the user's head when operating motor vehicles.

A significant problem is presented by cords used in conjunction with current mobile devices, and specifically with the use of earpiece cords with such devices. The problem arises when the mobile device is not in use, and the earpiece must be stored for later use. As earpiece cords must be long enough to accommodate placing the mobile device a distance away from the user's head (for example, in a pocket), these earpiece cords are generally long enough to become tangled when casually stored between uses. For example, if a user were to place the mobile device and earpiece into a clothing pocket or handbag, it is not uncommon for the user to find that the earpiece cord has become tangled when removing the earpiece for later use. Not only can this tangling become irritating (requiring the user to untangle the cord), but in the case of mobile/cellular/cordless phones it can also lead to missed calls (if the cord cannot be untangled in time to accept an incoming call) or unsafe driving (if the user decides to remove the cord and operate the mobile phone “hands-on” in order to avoid missing a call due to a tangled earpiece cord).

### SUMMARY

A preferred embodiment according to the present invention is a device, comprising a center region having a first end and a second end; a first end region coupled to the first end of the center region, the first end region axially longer than the center region and forming first retaining regions, the first end region including a first pincer region; and a second end region coupled to the second end of the center region, the second end region axially longer than the center region and forming second retaining regions, the second end region including a second pincer region; wherein the first and second pincer regions include a gap that resistively allows passage of a cord.

A preferred method according to the present invention comprises inserting a first portion of a cord into a first end region of a cord holder, the first end region including a first holding region to hold the first portion of the cord; wrapping a remaining length of the cord around a cord retaining area of the cord holder, the cord retaining area formed from the first end region, a center region coupled to the first end region, and a second end region coupled to the center region, the first end region and second end region axially longer than the center region; and inserting a second portion of the cord into a second end region of the cord holder, the second end region including a second holding region to hold the second portion of the earpiece cord.

### BRIEF DESCRIPTION OF THE DRAWINGS

FIG. 1 is a prior art earpiece with earpiece cord.

FIG. 2 is a perspective view of a preferred cord holder according to the present invention.

FIG. 3 is a top view of the preferred cord holder according to the present invention.

FIG. 4 is a first side view of the preferred cord holder according to the present invention.

FIG. 5 is a second side view of the preferred cord holder according to the present invention.

FIG. 6 is a flow chart for a preferred method of using the preferred cord holder, according to the present invention.

FIG. 7 is a perspective view of the preferred cord holder with an earpiece in a short state, according to the present invention.

FIG. 8 is a flow chart for a preferred method of using the preferred cord holder according to the present invention.

FIG. 9 is a perspective view of the preferred cord holder with an earpiece in a long state, according to the present invention.

FIG. 10 is a perspective view of the preferred cord holder in a first configuration during a second embodiment of a method of using the cord holder, according to the present invention.

FIG. 11 is a perspective view of the preferred cord holder in a second configuration during the second embodiment of a method of using the cord holder, according to the present invention.

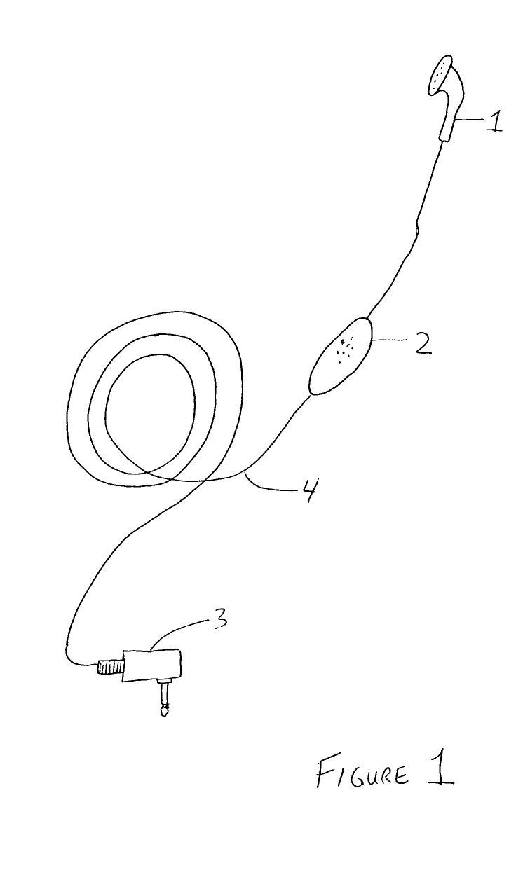

### DETAILED DESCRIPTION OF PREFERRED EMBODIMENTS

The preferred exemplary embodiments according to the present invention are a cord holder and methods for using the cord holder that allow a user to achieve untangled cords in easy and fast manner, using an easy to manufacture design. The user may vary the effective length of the cord as desired with minimum effort. Thus the user may keep the cord in a short state, then quickly release the cord into an extended state when an extended length is desired (e.g., “hands-free” mobile phone use), and then wind the cord on the cord holder to return to the short state for tangle-free storage. One preferred embodiment according to the present invention is a cord holder and method for use thereof configured for use with an earpiece cord of a mobile device.

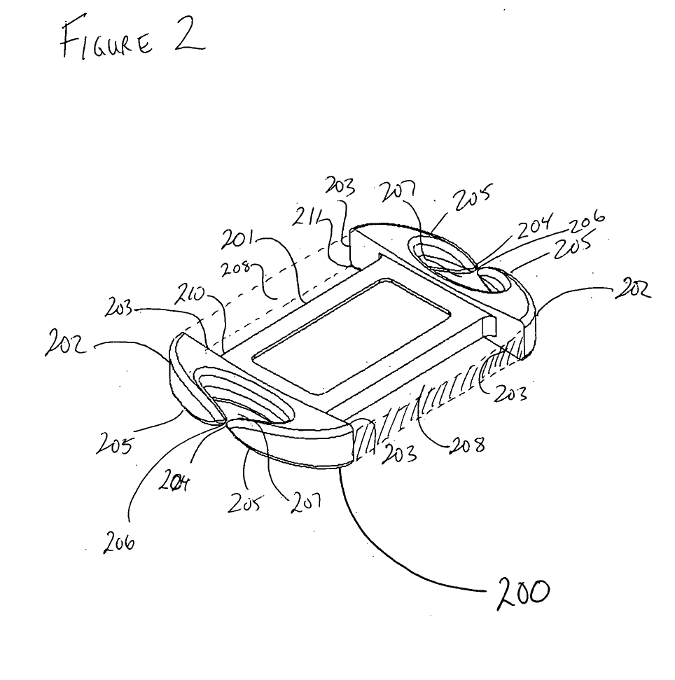

FIG. 2 shows a perspective view of the preferred cord holder. Cord holder 200 includes a center region 201 and two end regions 202. End regions 202 are coupled to center region 201 on opposite longitudinal ends 210, 211 of the center region 201. End regions 202 extend axially further than center region 201, forming retaining regions 203. The area defined by the retaining regions 203 and center region 201 may be referred to as the cord holding area 208. As will be described more fully below, retaining regions 203 allow for the untangled retaining of cords held by cord holder 200. End regions 202 further include a pincer region 204, formed, for example, by opposing members 205. Opposing members 205 may be positioned such that a gap 206 exists between the opposing members 205 that resistively allows the passage of a cord through the gap (and thus requires a degree of force to pass a cord through the pincer region 204). A holding region 207 may also be formed by the opposing members 205, which may be where a cord is held after passage through the pincer region 204.

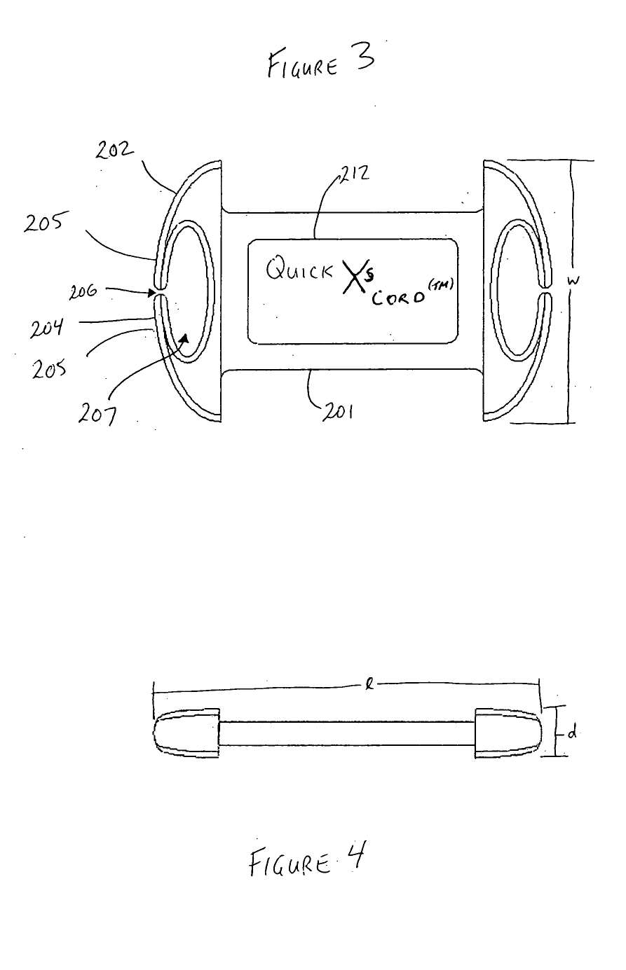

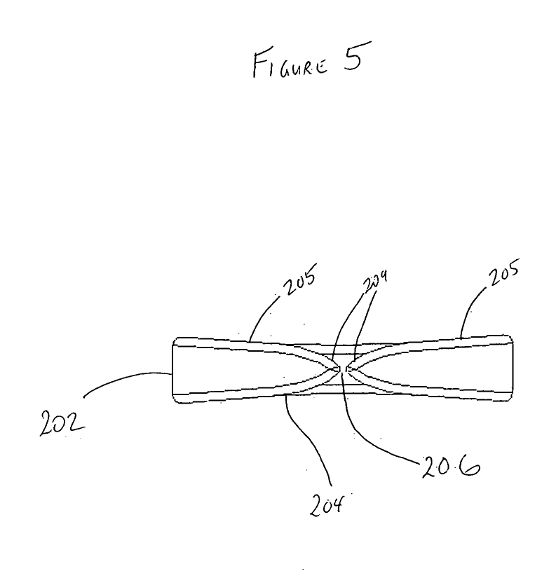

FIGS. 3 and 4 show a top view and a first side view (respectively) of the preferred cord holder according to the present invention. The preferred cord holder has a relatively planar shape, having a thickness “d” several times smaller than its width “w” or length “l”. Although more rounded/cylindrical shapes are possible, the planar shape is convenient for use with mobile devices (for example, the cord holder may be pressed against the mobile device while the device is in a carrier pocket or other relatively rectilinear space), and achieves more cord storage relative to the size of the cord holder. Center region 201 may be solid, or may be hollowed out to any degree such that the structural integrity of center region 201 is not compromised. The preferred cord holder 200 uses a solid center region 201, which allows for the placement of text or graphics 212 on the center region 201 (for example, company logos or contact information).

FIG. 5 shows a second side view of the preferred cord holder according to the present invention. This second side view shows an end region 202, and particularly the opposing members 205 of pincer region 204 of end region 202. Gap 206 may be formed such that standard thickness cords may be resistively passed through gap 206—and therefore causing the cord to be held in the holding region 207 (see FIG. 3) until a sufficient force is applied to pass it again through gap 206. Preferably, gap 206 is formed by tips 209 of opposing members 205, which allows for resistance to passage, but also avoids inadvertent “snagging” in the gap 206 (e.g., enough force is applied to enter the gap 206, but not enough force is applied to exit the gap 206). However, to provide strength to withstand repeated insertion cycles (and the wear of normal use), the opposing members are preferably formed as thick as possible. Hence, as shown in FIG. 5, opposing members 205 are tapered from a thickness similar to that of the rest of end region 202 to a point thickness at tips 209.

Cord holder 200 is preferably manufactured as molded plastic, such that the center region 201 and end regions 202 are all formed from a single plastic mold. Of course, other manufacturing processes may be used, and center region 201 and end regions 202 (and their constituent parts) may be separately formed and attached as convenient. An advantage of forming cord holder 200 through a single molding process is that intricate manufacturing and assembly steps may be avoided.

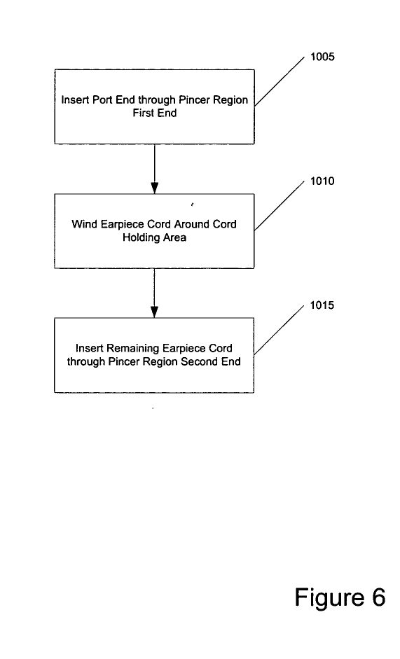

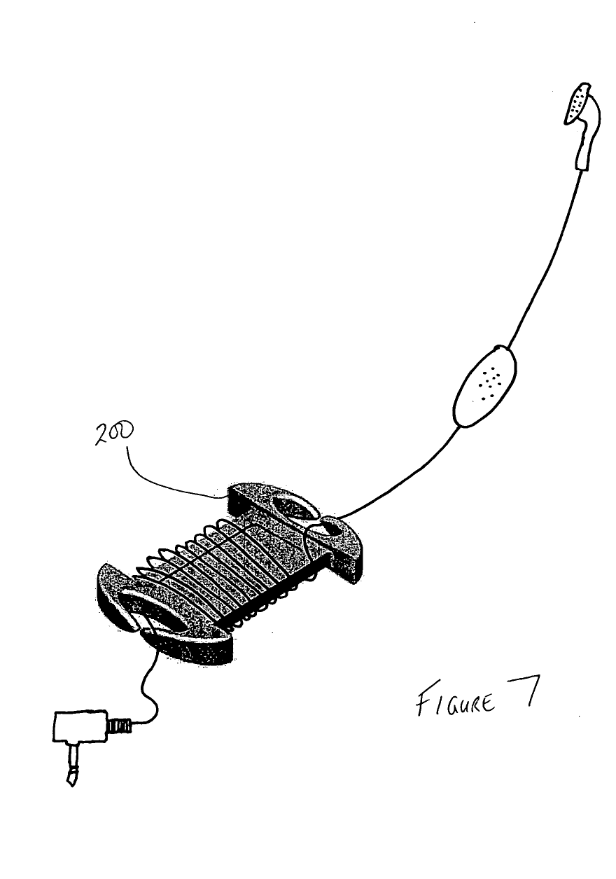

FIG. 6 shows a flow chart for a first preferred method for use of the cord holder according to the present invention in conjunction with an earpiece cord. In step 1005, a portion of the earpiece cord near to the port end of the earpiece is inserted through the pincer region 204 of one of the end regions 202, such that a desired length of earpiece cord is positioned between the earpiece port and the pincer region 204. The gap 206 in pincer region 204 resists passage of the earpiece cord, but will allow passage when sufficient force is applied. This portion of the earpiece cord is now within the holding region 207.

The remaining earpiece cord may then be wound around the cord holding area 208 of center region 201, i.e., between the retaining regions 203 (step 1010). Best results have been found when this winding starts at one end of the cord holding area 208 (against one of the retaining regions 203), and continues longitudinally over the cord holding area 208 until a desired length of earpiece cord is remaining. Should the other end of the cord holding area 208 be reached during the winding, the winding may continue in the opposite direction overlapping the previously wound portions of earpiece cord, preferably in a fashion that spreads the earpiece cord evenly over the cord holding area 208 (which can provide for easy unraveling).

When the desired length of earpiece cord is reached, the remaining portion of earpiece cord may be inserted through the pincer region 204 of the end region 202 opposite the end region 202 through which the port end of the earpiece cord was inserted and is now held (step 1015). Again, the gap 206 of pincer region 204 resists passage of the earpiece cord, requiring a sufficient amount of force to obtain passage through the gap 206 and into holding region 207. The earpiece cord may now be referred to as being in a “short state”—the effective length of the earpiece cord combined with the cord holder 200 is significantly shorter than when fully extended. FIG. 7 shows the cord holder 200 and earpiece cord in the short state.

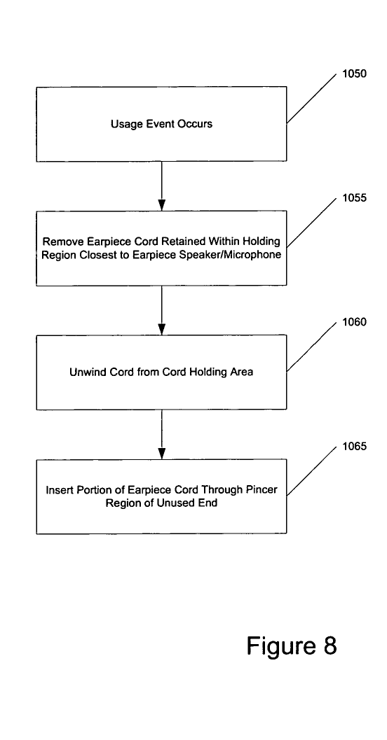

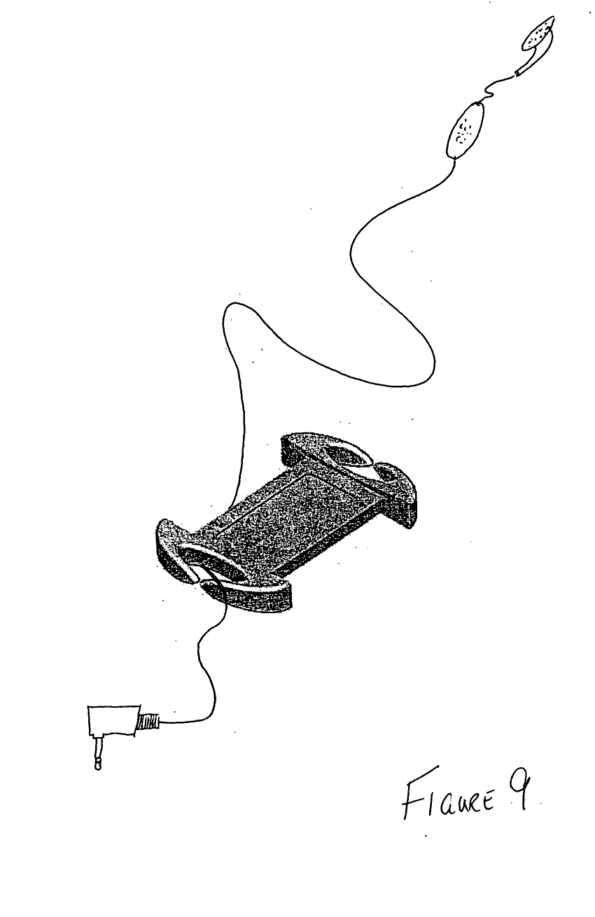

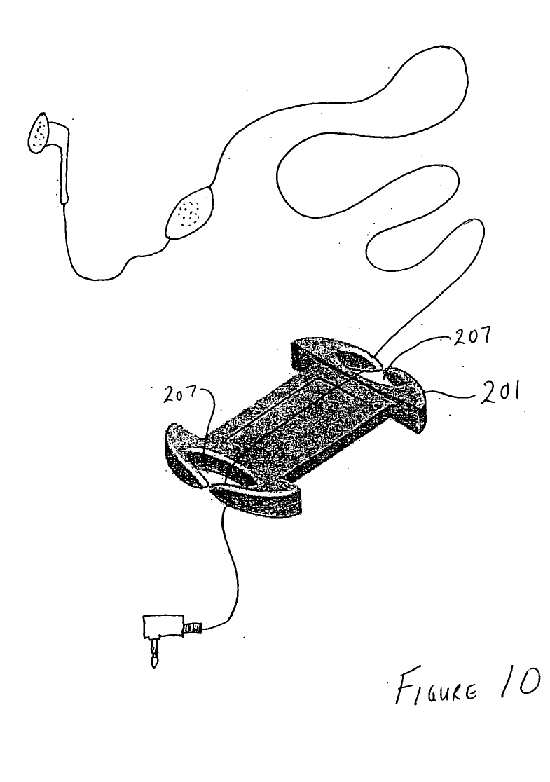

FIG. 8 is a flow chart illustrating the preferred method for extension of the earpiece cord from the “short state” to an “extended state”—which may be desired when the earpiece is, for example, being used in a “hands-free” manner. In step 1050, an event occurs that causes the user to desire to extend the effective length of the earpiece cord from the current short state. This event may be, for example, an indication that a telephone call is being received at the mobile device, as well as the desire to place a telephone call using the mobile device. The user may then remove the earpiece cord portion that is retained within the holding region 207 of end section 202 that is closest to the earpiece speaker/microphone facilities (step 1055). This removal can be achieved by applying a force sufficient to overcome the resistance provided by the gap 206 of pincer region 204, such that the earpiece cord passes through the gap 206 and is no longer retained in holding region 207. Once the earpiece cord has been removed from holding region 207, the earpiece cord may be unwound from cord holding area 208 (step 1060), preferably by lifting the speaker/microphone facilities to the user's head and allowing the cord holder 200 to drop. Unwinding of the earpiece cord is fast, as the earpiece cord quickly loosens around the cord holding area 208 once removed from the holding region 207, while the pull of gravity downward acts to unwind the cord as the cord holder 200 falls. The arrangement of retaining regions 203—protruding outwardly from the center region 201 in a substantially perpendicular manner—aids in the quick unwinding of the earpiece cord, as the cord is relatively unrestricted throughout its exposed portions. FIG. 9 shows the earpiece and cord holder 201 in such an extended state.

Since a portion of the earpiece cord still remains within one of the end regions 202 of the cord holder 200 (the portion closer to the port end of the earpiece cord), the cord holder 200 remains attached to the earpiece. This allows for quick re-winding of the earpiece cord when the user desires to put the cord back to the short state, as the cord holder remains in close proximity to the earpiece cord (and thus also protects the cord holder from falling off and becoming lost), and the first portion of the earpiece cord is already being held (see FIG. 6, step 1005), requiring only the winding and securing steps to be performed.

It may be desirable to not have the earpiece cord fully extended. For example, the earpiece cord may be too long even for hands-free use when fully extended as shown in FIG. 9. Alternatively, the earpiece cord may be unwound to a desired length, and then a portion of the earpiece cord inserted through gap 206 of pincer region 204 of end region 202 from which the earpiece cord was just previously removed (step 1065). In this current embodiment, this end region will be the end region which does not have any portions of the earpiece cord being held in its holding region 207—the end region 202 opposite the end region into which the portion of the earpiece cord near to the port end has been inserted. The earpiece/cord holder combination is now in the extended state, however some portion of earpiece cord remains wound around the cord retaining area 208, and the effective length of the earpiece/cord holder combination is not its maximum length.

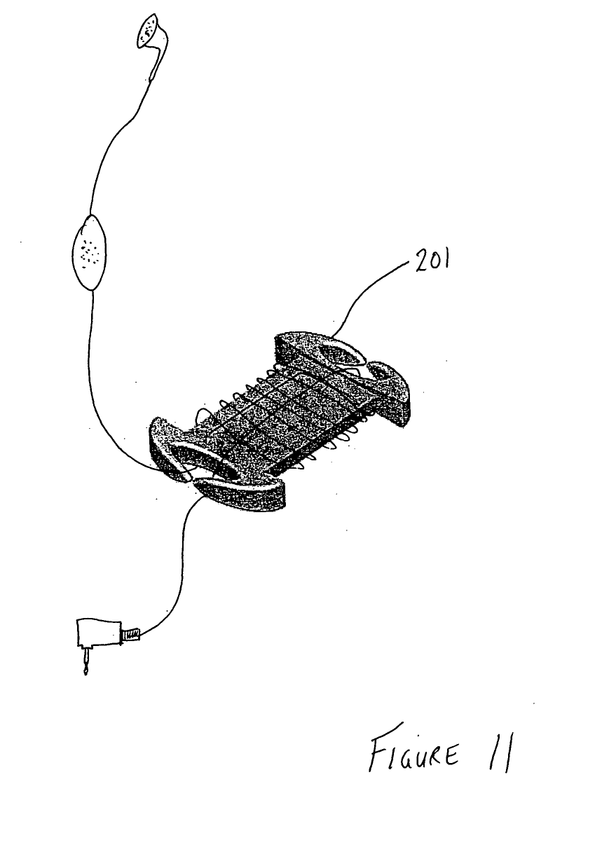

In an alternate embodiment, the earpiece cord may be arranged such that three portions of the earpiece cord are held within holding regions 207 of cord holder 200. FIGS. 10 and 11 illustrate the earpiece and cord holder 200 during two different points of this alternative method. As noted for the previous embodiment (see FIG. 6), initially, a first portion of the earpiece cord near to the port end may be inserted into the holding region 207 of one of the end regions 202. The remaining earpiece cord length (i.e., the portion extending away from the port towards the speaker/microphone) is then laid longitudinally over the cord holder 200 extending toward the opposite end region 202, and inserted into the holding region 207 of the opposite end region 202. FIG. 10 illustrates the configuration of the earpiece and cord holder 200 at this point. The remaining earpiece cord is then wrapped around the cord retaining area 208 of the cord holder 200 to a desired earpiece cord length, and the remaining earpiece cord is inserted into the holding region 207 of the end section 202 into which the first portion of the earpiece cord has already been inserted. FIG. 11 illustrates this configuration of the earpiece and cord holder 200.

When an event occurs such that the user of the earpiece desires to extend the effective length of the earpiece, the user need only remove the last (i.e., third) inserted portion of the earpiece cord from its holding region 207 to unwind the earpiece cord from the cord holding area 208. Since two portions of the earpiece cord remain within their respective holding regions 207, the cord holder 200 remains attached to the earpiece cord, and is unlikely to detach. Furthermore, since two portions of the earpiece cord are being retained (see FIG. 10), it is likely that the cord holder will remain in the location it was originally placed (due to the additional friction caused by deflection of the earpiece cord).

The exemplary cord holder and method of use has been described above in reference to an earpiece cord for use with mobile devices. Embodiments of the present invention may also be used in conjunction with other cords, and/or with devices other than mobile devices. For example, the cord holder may be used in conjunction with adapter cords, audio cables, and other cords. In such cases, the gap may be adjusted to accommodate the cord diameter, such that the cord resistively passes through the gap. Likewise, the size of the cord holder may be increased (or decreased) to accommodate the expected cord length, diameter and flexibility of the type of cord expected to be used with the cord holder. The benefits provided by the exemplary cord holder in the context of the earpiece cord may be realized when used with other cords and devices as well (e.g., untangled cords, quick unwinding, quick rewinding, mid-length positioning).

In the preceding specification, the invention has been described with reference to specific exemplary embodiments thereof. It will, however, be evident that various modifications and changes may be made thereunto without departing from the broader spirit and scope of the invention as set forth in the claims that follow. The specification and drawings are accordingly to be regarded in an illustrative rather than restrictive sense.

1. A device, comprising:
a center region having a first end and a second end;
a first end region coupled to the first end of the center region, the first end region axially longer than the center region and forming first retaining regions, the first end region including a first pincer region;
a second end region coupled to the second end of the center region, the second end region axially longer than the center region and forming second retaining regions, the second end region including a second pincer region;
wherein the first and second pincer regions include a gap that resistively allows passage of a cord.

2. The device of claim 1, wherein the center region is solid.

3. The device of claim 1, wherein the first retaining regions, the second retaining regions and the center region form a cord holding area.

4. The device of claim 1, wherein each of the first and second end regions further include a holding region into which the cord is held after being passed through the gap.

5. The device of claim 1, wherein each of the first and second pincer regions further includes opposing members, and the gap included in each of the first and second pincer regions is formed by the opposing members.

6. The device of claim 5, wherein each of the opposing members includes a tip, and the tips of the opposing members are disposed to form the gap.

7. The device of claim 1, wherein the first and second retaining regions extend perpendicular to the center region.

8. A method, comprising:
inserting a first portion of a cord into a first end region of a cord holder, the first end region including a first holding region to hold the first portion of the cord;
wrapping a remaining length of the cord around a cord retaining area of the cord holder, the cord retaining area formed from the first end region, a center region coupled to the first end region, and a second end region coupled to the center region, the first end region and second end region axially longer than the center region;
inserting a second portion of the cord into a second end region of the cord holder, the second end region including a second holding region to hold the second portion of the earpiece cord.

9. The method of claim 8, further comprising:
inserting a third portion of the cord into the first end region of the cord holder after the wrapping, such that the third portion of the cord is held in the first holding region;
wherein the inserting the second portion of the cord into the second end region is performed before the wrapping.

10. An earpiece cord holding device, comprising:
a center region having a first end and a second end;
a first end region coupled to the first end of the center region, the first end region axially longer than the center region and forming first retaining regions, the first end region including a first pincer region;
a second end region coupled to the second end of the center region, the second end region axially longer than the center region and forming second retaining regions, the second end region including a second pincer region;
wherein the first and second pincer regions include a gap that resistively allows passage of an earpiece cord.

11. The device of claim 10, wherein the center region is solid.

12. The device of claim 10, wherein the first retaining regions, the second retaining regions and the center region form a cord holding area.

13. The device of claim 10, wherein each of the first and second end regions further include a holding region into which the earpiece cord is held after being passed through the gap.

14. The device of claim 10, wherein each of the first and second pincer regions further includes opposing members, and the gap included in each of the first and second pincer regions is formed by the opposing members.

15. The device of claim 14, wherein each of the opposing members includes a tip, and the tips of the opposing members are disposed to form the gap.

16. The device of claim 10, wherein the first and second retaining regions extend perpendicular to the center region.
